(19) United States
(12) Patent Application Publication
(10) Pub. No.: US 2010/0039500 A1
(43) Pub. Date: Feb. 18, 2010

(54) Self-Contained 3D Vision System Utilizing Stereo Camera and Patterned Illuminator

(76) Inventors: Matthew Bell, Palo Alto, CA (US); Raymond Chin, Sant Clara, CA (US); Matthew Vieta, San Jose, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 12/372,674

(22) Filed: Feb. 17, 2009

Related U.S. Application Data
(60) Provisional application No. 61/065,903, filed on Feb. 15, 2008.

(51) Int. Cl. H04N 13/02

(52) U.S. Cl. 348/46; 348/E13.074

(57) ABSTRACT

A self-contained hardware and software system that allows reliable stereo vision to be performed. The vision hardware for the system, which includes a stereo camera and at least one illumination source that projects a pattern into the camera's field of view, may be contained in a single box. This box may contain mechanisms to allow the box to remain securely and stay in place on a surface such as the top of a display. The vision hardware may contain a physical mechanism that allows the box, and thus the camera's field of view, to be tilted upward or downward in order to ensure that the camera can see what it needs to see.

### CROSS-REFERENCE TO RELATED APPLICATIONS

The present application claims the priority benefit of U.S. provisional patent application No. 61/065,903 filed Feb. 15, 2008 and entitled “Self-Contained 3D Vision System Utilizing Stereo Camera and Patterned Illuminator,” the disclosure of which is incorporated by reference.

### BACKGROUND

1. Field of the Invention

The present invention generally relates to three-dimensional vision systems. More specifically, the present invention relates to three-dimensional vision systems utilizing a stereo camera and patterned illuminator.

2. Background of the Invention

Stereo vision systems allow computers to perceive the physical world in three-dimensions. Stereo vision systems are being developed for use in a variety of applications including gesture interfaces. There are, however, fundamental limitations of stereo vision systems. Since most stereo camera based vision systems depend on an algorithm that matches patches of texture from two cameras in order to determine disparity, poor performance often results when the cameras are looking at an object with little texture.

### SUMMARY OF THE INVENTION

An exemplary embodiment of the present invention includes a self-contained hardware and software system that allows reliable stereo vision to be performed. The system is not only easy for an average person to set up but also to configure to work with a variety of televisions, computer monitors, and other video displays. The vision hardware for the system, which includes a stereo camera and at least one illumination source that projects a pattern into the camera's field of view, may be contained in a single box. This box may contain mechanisms to allow the box to remain securely and stay in place on a surface such as the top of a display. The vision hardware may contain a physical mechanism that allows the box, and thus the camera's field of view, to be tilted upward or downward in order to ensure that the camera can see what it needs to see.

The system is designed to work with and potentially add software to a separate computer that generates a video output for the display. This computer may take many forms including, but not limited to, a video game console, personal computer, or a media player such as a digital video recorder, DVD player, or a satellite radio.

Vision software may run on an embedded computer inside the vision hardware box, the separate computer that generates video output, or some combination of the two. The vision software may include but is not limited to stereo processing, generating depth from disparity, perspective transforms, person segmentation, body tracking, hand tracking, gesture recognition, touch detection, and face tracking. Data produced by the vision software may be made available to software running on the separate computer in order to create interactive content that utilizes a vision interface. This content may be sent to the display for display to a user.

### BRIEF DESCRIPTION OF THE FIGURES

FIG. 1 illustrates an exemplary configuration for the hardware of a vision box.

FIG. 2 illustrates the flow of information through an exemplary embodiment of the invention.

FIG. 3 illustrates one exemplary implementation of the vision box of FIG. 1.

FIG. 4 illustrates an exemplary embodiment of an illuminator.

### DETAILED DESCRIPTION

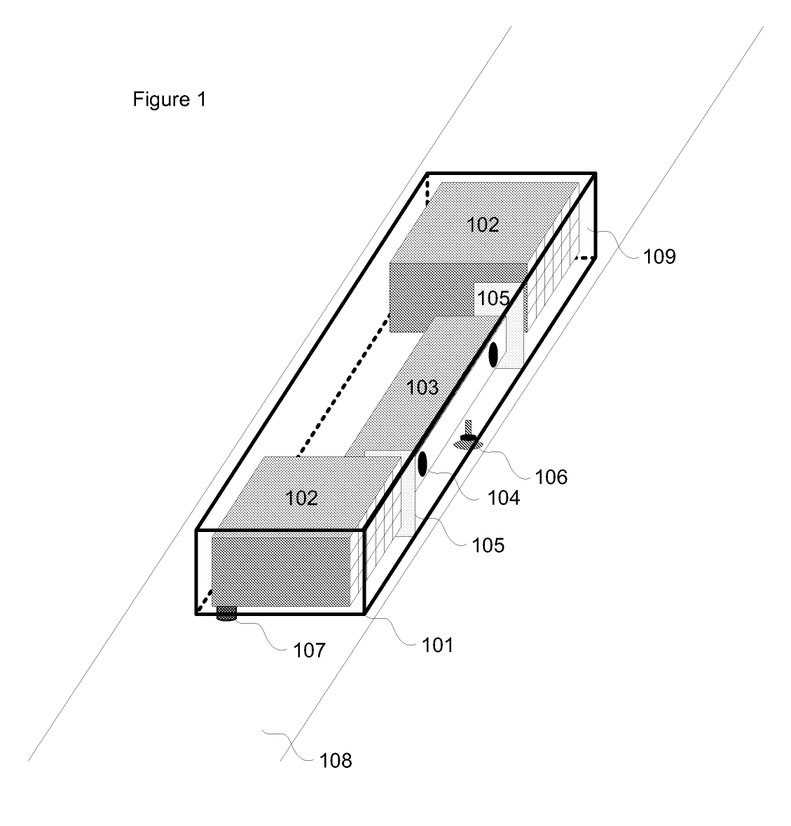

FIG. 1 illustrates an exemplary configuration for the hardware of a vision box. The power and data cables have been omitted from the diagram for clarity. The vision box 101 is shown, in FIG. 1, resting on top of a flat surface 108 that could be the top of a display. The vision box 101 contains one or more illuminators 102. Each of the illuminators 102 creates light with a spatially varying textured pattern. This light pattern illuminates the volume of space viewed by the camera. In an exemplary embodiment, the pattern has enough contrast to be seen by the camera over the ambient light, and has a high spatial frequency that gives the vision software detailed texture information.

A stereo camera 103, with two or more cameras 104, is also contained in the vision box 101. The stereo camera 103 may pass raw analog or digital camera images to a separate computer (not shown) for vision processing. Alternately, the stereo camera 103 may contain specialized circuitry or an embedded computer capable of onboard vision processing. Commercially available stereo cameras include for example, the Tyzx DeepSea™ and the Point Grey Bumblebee™. Such cameras may be monochrome or color and may be sensitive to one or more specific bands of the electromagnetic spectrum including visible light, near-infrared, far infrared, and ultraviolet. Some cameras, like the Tyzx DeepSea™, do much of their stereo processing within the camera enclosure using specialized circuitry and an embedded computer.

The vision box 101 may be designed to connect to a separate computer (not shown) that generates a video output for the display based in part on vision information provided by the vision box 11. This computer may take many forms including but not limited to a video game console, personal computer, or a media player such as a digital video recorder, DVD player, or a satellite radio. Vision processing that does not occur within the vision box 101 may occur on the separate computer.

The illuminators 102 emit light that is invisible or close to invisible to a human user; the camera 103 is sensitive to this light. This light may be in the near-infrared frequency. A front side 109 of the vision box 101 may contain a material that is transparent to light emitted by the illuminators. This material may also be opaque to visible light thereby obscuring the internal workings of the vision box 101 from a human user. Alternately, the front side 109 may consist of a fully opaque material that contains holes letting light out of the illuminator 102 and into the camera 103.

The vision box 101 may contain one or more opaque partitions 105 to prevent the illuminator 102 light from ‘bouncing around’ inside the box and into the camera 103. This ensures the camera 103 is able to capture a high quality, high contrast image.

The vision box 101 may be placed on a variety of surfaces including some surfaces high off the ground and may be pulled on by the weight of its cable. Thus, it may be important that the vision box does not move or slip easily. As a result, the design for the vision box 101 may include high-friction feet 107 that reduce the chance of slippage. Potential high friction materials include rubber, sticky adhesive surfaces, and/or other materials. Alternately, the feet 107 may be suction cups that use suction to keep the vision box in place. Instead of having feet, the vision box may have its entire bottom surface covered in a high friction material. The vision box 101 may alternatively contain a clamp that allows it to tightly attach to the top of a horizontal surface such as a flat screen TV.

Because the vision box 101 may be mounted at a variety of heights, the camera 103 and the illuminator 102 may need to tilt up or down in order to view the proper area. By enclosing the camera 103 and the illuminator 102 in a fixed relative position inside the vision box 101, the problem may reduced or eliminated through simple reorientation of the box 101. As a result, the vision box 101 may contain a mechanism 106 that allows a user to easily tilt the vision box 101 up or down. This mechanism 106 may be placed at any one of several locations on the vision box 101; a wide variety of design options for the mechanism 106 exist. For example, the mechanism 106 may contain a pad attached to a long threaded rod which passes through a threaded hole in the bottom of the vision box 101. A user could raise and lower the height of the pad relative to the bottom of the vision box 101 by twisting the pad, which would in turn twist the rod.

The overall form factor of the vision box 1 may be relatively flat in order to maximize stability and for aesthetic reasons. This can be achieved by placing the illuminators 102 to the side of the stereo camera 103 and creating illuminators 102 that are relatively flat in shape.

The vision box 101 may receive power input from an external source such as a wall socket or another electronic device. If the vision box 101 is acting as a computer peripheral or video game peripheral, it may draw power from the separate computer or video game console. The vision box 101 may also have a connection that transfers camera data, whether raw or processed, analog or digital, to a separate computer. This data may be transferred wirelessly on a cable separate from the power cable or on a wire that is attached to the power cable. There may be only a single cable between the vision box 101 and the separate computer with this single cable containing wires that provide both power and data. The illuminator 102 may contain monitoring circuits that would allow an external device to assess its current draw, temperature, number of hours of operation, or other data. The current draw may indicate whether part or all of the illuminator 102 has burnt out. This data may be communicated over a variety of interfaces including serial and USB.

The vision box 101 may contain a computer (not shown) that does processing of the camera data. This processing may include, but is not limited to, stereo processing, generating depth from disparity, perspective transforms, person segmentation, body tracking, hand tracking, gesture recognition, touch detection, and face tracking. Data produced by the vision software may also be used to create interactive content that utilizes a vision interface. The content may include a representation of the user's body and/or hands thereby allowing the users to tell where they are relative to virtual objects in the interactive content. This content may be sent to the display for display to a user.

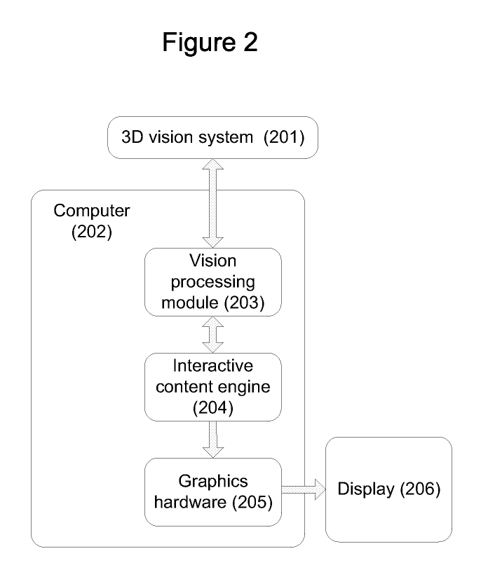

FIG. 2 illustrates the flow of information through an exemplary embodiment of the invention. 3D vision system 201 provides data to a separate computer 202. Each stage of vision processing may occur within the 3D vision system 201, within vision a processing module 203, or both. Information from the vision processing module 203 may be used to control the 3D vision system 201.

The vision processing module 203 may send signals to alter the gain level of the cameras in the vision system 201 in order to properly see objects in the camera's view. The output of the vision processing in the 3D vision system 201 and/or from the vision processing module 203 may be passed to an interactive content engine 204. The interactive content engine 204 may be designed to take the vision data, potentially including but not limited to, user positions, hand positions, head positions, gestures, body shapes, and depth images, and use it to drive interactive graphical content.

Examples of interactive content engines 204 include, but are not limited to, Adobe's Flash platform and Flash content, the Reactrix Effects Engine, and a computer game or console video game. The interactive content engine 204 may also provide the vision processing module 203 and/or the 3D vision system 201 with commands in order to optimize how vision data is gathered. Video images from the interactive content engine 204 may be rendered on graphics hardware 205 and sent to a display 206 for display to the user.

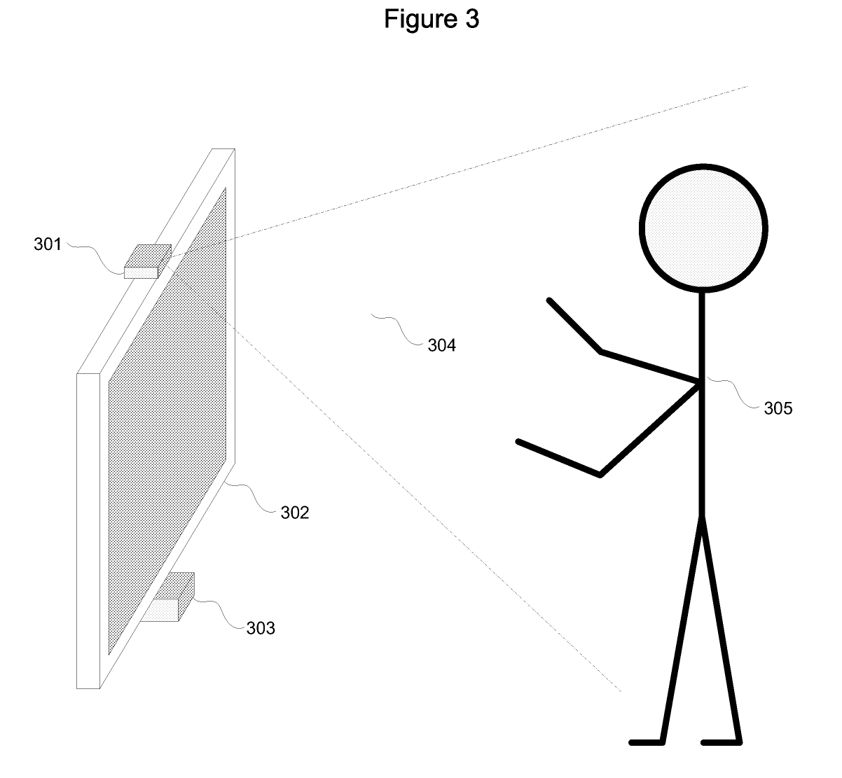

FIG. 3 illustrates one exemplary implementation of the vision box of FIG. 1. The vision box 301 sits on top of display 302. A separate computer 303 takes input from the vision box 301 and provides video (and potentially audio) content for display on the display 302. The vision box 301 is able to see objects in, and has properly illuminated, interactive space 304. One or more users 305 may stand in the interactive space 304 in order to interact with the vision interface.

### Vision Details

The following is detailed discussion of the computer vision techniques, which may be put to use in either the 3D vision system 201 or the vision processing module 203.

3D computer vision techniques using algorithms such as those based on the Marr-Poggio algorithm may take as input two or more images of the same scene taken from slightly different angles. These Marr-Poggio-based algorithms are examples of stereo algorithms. These algorithms may find texture patches from the different cameras' images that correspond to the same part of the same physical object. The disparity between the positions of the patches in the images allows the distance from the camera to that patch to be determined, thus providing 3D position data for that patch. The performance of this algorithm degrades when dealing with objects of uniform color because uniform color makes it difficult to match up the corresponding patches in the different images.

Since illuminator 102 creates light that is textured, it can improve the distance estimates of some 3D computer vision algorithms. By lighting objects in the interactive area with a pattern of light, the illuminator 102 improves the amount of texture data that may be used by the stereo algorithm to match patches.

Several methods may be used to remove inaccuracies and noise in the 3D data. For example, background methods may be used to mask out 3D data from areas of the camera's field of view that are known to have not moved for a particular period of time. These background methods (also known as background subtraction methods) may be adaptive, allowing the background methods to adjust to changes in the background over time. These background methods may use luminance, chrominance, and/or distance data from the cameras in order to form the background and determine foreground. Once the foreground is determined, 3D data gathered from outside the foreground region may be removed.

In one embodiment, a color camera may be added to vision box 101 to obtain chrominance data for the 3D data of the user and other objects in front of the screen. This chrominance data may be used to acquire a color 3D representation of the user, allowing their likeness to be recognized, tracked, and/or displayed on the screen.

Noise filtering may be applied to either the depth image (which is the distance from the camera to each pixel of the camera's image from the camera's point of view), or directly to the 3D data. For example, smoothing and averaging techniques such as median filtering may be applied to the camera's depth image in order to reduce depth inaccuracies. As another example, isolated points or small clusters of points may be removed form the 3D data set if they do not correspond to a larger shape; thus eliminating noise while leaving users intact.

The 3D data may be analyzed in a variety of ways to produce high level information. For example, a user's fingertips, fingers, and hands may be detected. Methods for doing so include various shape recognition and object recognition algorithms. Objects may be segmented using any combination of 2D/3D spatial, temporal, chrominance, or luminance data. Furthermore, objects may be segmented under various linear or non-linear transformations of the aforementioned domains. Examples of object detection algorithms include, but are not limited to deformable template matching, Hough transforms, and the aggregation of spatially contiguous pixels/voxels in an appropriately transformed space.

As another example, the 3D points belonging to a user may be clustered and labeled such that the cluster of points belonging to the user is identified. Various body parts, such as the head and arms of a user may be segmented as markers. Points may also be also clustered in 3-space using unsupervised methods such as k-means, or hierarchical clustering. The identified clusters may then enter a feature extraction and classification engine. Feature extraction and classification routines are not limited to use on the 3D spatial data buy may also apply to any previous feature extraction or classification in any of the other data domains, for example 2D spatial, luminance, chrominance, or any transformation thereof.

Furthermore, a skeletal model may be mapped to the 3D points belonging to a given user via a variety of methods including but not limited to expectation maximization, gradient descent, particle filtering, and feature tracking. In addition, face recognition algorithms, such as eigenface or fisherface, may use data from the vision system, including but not limited to 2D/3D spatial, temporal, chrominance, and luminance data, in order to identify users and their facial expressions. Facial recognition algorithms used may be image based, or video based. This information may be used to identify users, especially in situations where they leave and return to the interactive area, as well as change interactions with displayed content based on their face, gender, identity, race, facial expression, or other characteristics.

Fingertips or other body parts may be tracked over time in order to recognize specific gestures, such as pushing, grabbing, dragging and dropping, poking, drawing shapes using a finger, pinching, and other such movements.

The 3D vision system 101 may be specially configured to detect specific objects other than the user. This detection can take a variety of forms; for example, object recognition algorithms may recognize specific aspects of the appearance or shape of the object, RFID tags in the object may be read by a RFID reader (not shown) to provide identifying information, and/or a light source on the objects may blink in a specific pattern to provide identifying information.

### Details of Calibration

A calibration process may be necessary in order to get the vision box properly oriented. In one embodiment, some portion of the system comprising the 3D vision box 301 and the computer 302 uses the display, and potentially an audio speaker, to give instructions to the user 305. The proper position may be such that the head and upper body of any of the users 305 are inside the interactive zone 304 beyond a minimum distance, allowing gesture control to take place. The system may ask users to raise and lower the angle of the vision box based on vision data. This may include whether the system can detect a user's hands in different positions, such as raised straight up or pointing out to the side.

Alternately, data on the position of the user's head may be used. Furthermore, the system may ask the user to point to different visual targets on the display 302 (potentially while standing in different positions), allowing the system to ascertain the size of the display 302 and the position and angle of the vision box 301 relative to it. Alternately, the system could assume that the vision box is close to the plane of the display surface when computing the size of the display. This calculation can be done using simple triangulation based on the arm positions from the 3D depth image produced by the vision system. Through this process, the camera can calibrate itself for ideal operation

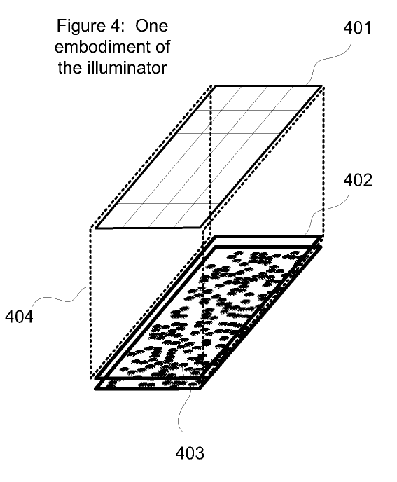

FIG. 4 illustrates an exemplary embodiment of an illuminator 102. Light from a lighting source 403 is re-aimed by a lens 402 so that the light is directed towards the center of a lens cluster 401. In one embodiment, the lens 402 is adjacent to the lighting source 403. In another embodiment, the lens 402 is adjacent to the lighting source 403 and has a focal length similar to the distance between the lens cluster 401 and the lighting source 403. This embodiment ensures that each emitter's light from the lighting source 403 is centered onto the lens cluster 401.

In a still further embodiment, the focal length of the lenses in the lens cluster 401 is similar to the distance between the lens cluster 401 and the lighting source 403. This focal length ensures that emitters from the lighting source 403 are nearly in focus when the illuminator 102 is pointed at a distant object. The position of components including the lens cluster 401, the lens 402, and/or the lighting source 403 may be adjustable to allow the pattern to be focused at a variety of distances. Optional mirrors 404 bounce light off of the inner walls of the illuminator 102 so that emitter light that hits the walls passes through the lens cluster 401 instead of being absorbed or scattered by the walls. The use of such mirrors allows low light loss in the desired “flat” configuration, where one axis of the illuminator is short relative to the other axes.

The lighting source 403 may consist of a cluster of individual emitters. The potential light sources for the emitters in the lighting source 403 vary widely; examples of the lighting source 403 include but are not limited to LEDs, laser diodes, incandescent bulbs, metal halide lamps, sodium vapor lamps, OLEDs, and pixels of an LCD screen. The emitter may also be a backlit slide or backlit pattern of holes. In a preferred embodiment, each emitter aims the light along a cone toward the lens cluster 401. The pattern of emitter positions can be randomized to varying degrees.

In one embodiment, the density of emitters on the lighting source 403 varies across a variety of spatial scales. This ensures that the emitter will create a pattern that varies in brightness even at distances where it is out of focus. In another embodiment, the overall shape of the light source is roughly rectangular. This ensures that with proper design of the lens cluster 401, the pattern created by the illuminator 102 covers a roughly rectangular area. This facilitates easy clustering of the illuminators 102 to cover broad areas without significant overlap.

In one embodiment, the lighting source 403 may be on a motorized mount, allowing it to move or rotate. In another embodiment, the emitters in the pattern may be turned on or off via an electronic control system, allowing the pattern to vary. In this case, the emitter pattern may be regular, but the pattern of emitters that are on may be random. Many different frequencies of emitted light are possible. For example, near-infrared, far-infrared, visible, and ultraviolet light can all be created by different choices of emitters. The lighting source 403 may be strobed in conjunction with the camera(s) of the computer vision system. This allows ambient light to be reduced.

The second optional component, a condenser lens or other hardware designed to redirect the light from each of the emitters in lighting source 403, can be implemented in a variety of ways. The purpose of this component, such as the lens 402 discussed herein, is to reduce wasted light by redirecting the emitters' light toward the center of the lens cluster 401, ensuring that as much of it goes through lens cluster 401 as possible. In a preferred embodiment, each emitter is mounted such that it emits light in a cone perpendicular to the surface of the lighting source 403. If each emitter emits light in a cone, the center of the cone can be aimed at the center of the lens cluster 401 by using a lens 402 with a focal length similar to the distance between the lens cluster 401 and the lighting source 403. In a preferred embodiment, the angle of the cone of light produced by the emitters is chosen such that the cone will completely cover the surface of the lens cluster 401. If the lighting source 403 is designed to focus the light onto the lens cluster 401 on its own, for example by individually angling each emitter, then the lens 402 may not be useful.

Implementations for the lens 402 include, but are not limited to, a convex lens, a plano-convex lens, a Fresnel lens, a set of microlenses, one or more prisms, and a prismatic film.

The third optical component, the lens cluster 401, is designed to take the light from each emitter and focus it onto a large number of points. Each lens 402 in the lens cluster 401 can be used to focus each emitter's light onto a different point. Thus, the theoretical number of points that can be created by shining the lighting source 403 through the lens cluster 401 is equal to the number of emitters in the lighting source multiplied by the number of lenses 402 in the lens cluster 401. For an exemplary lighting source with 200 LEDs and an exemplary emitter with 36 lenses, this means that up to 7200 distinct bright spots can be created. With the use of mirrors 404, the number of points created is even higher since the mirrors create “virtual” additional lenses in the lens cluster 401. This means that the illuminator 102 can easily create a high resolution texture that is useful to a computer vision system.

In an embodiment, all the lenses 402 in the lens cluster 401 have a similar focal length. The similar focal length ensures that the pattern is focused together onto an object lit by the illuminator 102. In another embodiment, the lenses 402 have somewhat different focal lengths so at least some of the pattern is in focus at different distances.

### User Representation

The user(s) or other objects detected and processed by the system may be represented on the display in a variety of ways. This representation on the display may be useful in allowing one or more users to interact with virtual objects shown on the display by giving them a visual indication of their position relative to the virtual objects. Forms that this representation may take include, but are not limited to, the following:

A digital shadow of the user(s) or other objects—for example, a two-dimensional (2D) shape that represents a projection of the 3D data representing their body onto a flat surface.

A digital outline of the user(s) or other objects—this can be thought of as the edges of the digital shadow.

The shape of the user(s) or other objects in 3D, rendered in the virtual space. This shape may be colored, highlighted, rendered, or otherwise processed arbitrarily before display.

Images, icons, or 3D renderings representing the users' hands or other body parts, or other objects.

The shape of the user(s) rendered in the virtual space, combined with markers on their hands that are displayed when the hands are in a position to interact with on-screen objects. (For example, the markers on the hands may only show up when the hands are pointed at the screen)

Points that represent the user(s) (or other objects) from the point cloud of 3D data from the vision system, displayed as objects. These objects may be small and semitransparent.

Cursors representing the position of users' fingers. These cursors may be displayed or change appearance when the finger is capable of a specific type of interaction in the virtual space.

Objects that move along with and/or are attached to various parts of the users' bodies. For example, a user may have a helmet that moves and rotates with the movement and rotation of the user's head.

Digital avatars that match the body position of the user(s) or other objects as they move. In one embodiment, the digital avatars are mapped to a skeletal model of the users' positions.

Any combination of the aforementioned representations.

In some embodiments, the representation may change appearance based on the users' allowed forms of interactions with on-screen objects. For example, a user may be shown as a gray shadow and not be able to interact with objects until they come within a certain distance of the display, at which point their shadow changes color and they can begin to interact with on-screen objects.

In some embodiments, the representation may change appearance based on the users' allowed forms of interactions with on-screen objects. For example, a user may be shown as a gray shadow and not be able to interact with objects until they come within a certain distance of the display, at which point their shadow changes color and they can begin to interact with on-screen objects.

### Interaction

Given the large number of potential features that can be extracted from the 3D vision system 101 (for example, the ones described in the “Vision Software” section herein), and the variety of virtual objects that can be displayed on the screen, there are a large number of potential interactions between the users and the virtual objects.

Some examples of potential interactions include 2D force-based interactions and influence image based interactions can be extended to 3D as well. Thus, 3D data about the position of a user could be used to generate a 3D influence image to affect the motion of a 3D object. These interactions, in both 2D and 3D, allow the strength and direction of the force the user imparts on virtual object to be computed, giving the user control over how they impact the object's motion.

Users may interact with objects by intersecting with them in virtual space. This intersection may be calculated in 3D, or the 3D data from the user may be projected down to 2D and calculated as a 2D intersection.

Visual effects may be generated based on the 3D data from the user. For example, a glow, a warping, an emission of particles, a flame trail, or other visual effects may be generated using the 3D position data or some portion thereof. Visual effects may be based on the position of specific body parts. For example, a user could create virtual fireballs by bringing their hands together. Users may use specific gestures to pick up, drop, move, rotate, or otherwise modify virtual objects onscreen.

### Mapping

The virtual space depicted on the display may be shown as either 2D or 3D. In either case, the system needs to merge information about the user with information about the digital objects and images in the virtual space. If the user is depicted two-dimensionally in the virtual space, then the 3D data about the user's position may be projected onto a 2D plane.

The mapping between the physical space in front of the display and the virtual space shown on the display can be arbitrarily defined and can even change over time. The actual scene seen by the users may vary based on the display chosen. In one embodiment, the virtual space (or just the user's representation) is two-dimensional. In this case, the depth component of the user's virtual representation may be ignored.

In one embodiment, the mapping is designed to act in a manner similar to a mirror, such that the motions of the user's representation in the virtual space as seen by the user are akin to a mirror image of the user's motions. The mapping may be calibrated such that when the user touches or brings a part of their body near to the screen, their virtual representation touches or brings the same part of their body near to the same part of the screen. In another embodiment, the mapping may show the user's representation appearing to recede from the surface of the screen as the user approaches the screen.

### User

Various embodiments provide for a new user interface, and as such, there are numerous potential uses. The potential uses include, but are not limited to

Sports: Users may box, play tennis (with a virtual racket), throw virtual balls, or engage in other sports activity with a computer or human opponent shown on the screen.

Navigation of virtual worlds: Users may use natural body motions such as leaning to move around a virtual world, and use their hands to interact with objects in the virtual world.

Virtual characters: A digital character on the screen may talk, play, and otherwise interact with people in front of the display as they pass by it. This digital character may be computer controlled or may be controlled by a human being at a remote location.

Advertising: The system may be used for a wide variety of advertising uses. These include, but are not limited to, interactive product demos and interactive brand experiences.

Multiuser workspaces: Groups of users can move and manipulate data represented on the screen in a collaborative manner.

Video games: Users can play games, controlling their onscreen characters via gestures and natural body movements.

Clothing: Clothes are placed on the image of the user on the display, allowing them to virtually try on clothes.

What is claimed is:

1. A self-contained 3D vision system, comprising:
a stereo camera configured to receive at least one image within a field of view;
an illumination source coupled to the stereo camera via a common housing, wherein the illumination source is configured to project a pattern onto the field of view; and
a mechanism coupled to the common housing configured to secure the common housing to a surface.
